(19) United States
(12) Patent Application Publication
(10) Pub. No.: US 2007/0209286 A1
(43) Pub. Date: Sep. 13, 2007

(54) Lip retention structure of molded part in weather-strip

(76) Inventor: Junji Nadano, Hiroshima (JP)

Correspondence Address: FLYNN THIEL BOUTELL & TANIS, P.C., 2026 RAMBLING ROAD, KALAMAZOO, MI, 49008-1631, US

(21) Appl. No.: 11/715,575

(22) Filed: Mar. 8, 2007

(30) Foreign Application Priority Data
Mar. 13, 2006 (JP) 2006-067322

(51) Int. Cl. E06B 7/22

(52) U.S. Cl. 49/498.1

(57) ABSTRACT

In a molded part composed of a seal, which is integrally formed at the lower end of a weather-strip mounted to a front pillar of an open-top car, and which covers the upper end of the seal of an inner seal mounted to the body at the lower side and joined, and a seal lip that makes flexible contact with an interior trim, a retainer with an L-shaped cross-section is integrally formed on the rear surface of the lip, and this retainer abuts the flange of the body panel; concurrently, it abuts the interior trim from the rear surface, whereby the lip base is supported, and when a door is closed and the seal of the molded part is compressed, floating of the end of the lip from the interior trim 12 is restricted.

### CROSS-REFERENCE TO THE RELATED ART

This application incorporates by reference the subject matter of Application No. 2006-67322, filed in Japan on Mar. 13, 2006, on which a priority claim is based under 35 U.S.C. §119 (a).

The present invention relates to a retention structure of a lip consisting of a molded part, which is integrally formed with a lower end of a weather-strip mounted to a front pillar of an open-top car or a front pillar and/or a rear pillar of a hard-top car, and which is separably joined without being integrated with an inner seal on the lower side under a beltline.

### BACKGROUND OF THE INVENTION

Taking a convertible type open-top car shown in FIG. 1 for example, a weather-strip 1 is mounted to a header of an upper edge of front glass and a front pillar and an inner seal 2 is mounted to a body panel on a lower side under a beltline BL, respectively, and the weather-strip 1 and the inner seal 2 are separably joined without being integrated. In the drawing, the symbol ‘4’ represents a weather-strip mounted to a door under the beltline BL, and ‘5’ represents a roof-side weather-strip mounted to the roof side. FIG. 1 shows the positional relationship of the weather-strip 1, the inner seal 2, the weather-strip 4 and the roof-side weather-strip 5 when the door and the roof are closed. When the roof is closed, the leading edge of the roof makes contact flexibly with the weather-strip 1 mounted to the header and seals it, and when the door is closed, the window glass of said door makes contact flexibly with the weather-strip 1 mounted to the front pillar and the roof-side weather-strip 5 and seals them, respectively; and, the door flexibly makes contact with the inner seal 2 under the beltline. Concurrently, the weather-strip 4 mounted to the door makes contact flexibly with the body and seals it.

FIG. 2 shows details of the portion ‘a’ in FIG. 1, and FIG. 3 shows a cross-section along the A-A line in FIG. 2. The blacked-out side of the triangular arrow in FIG. 2 indicates a molded part 3, and the non-blacked-out side indicates an extrusion part 6.

The inner seal 2 consists of a grip 9 that has a roughly U-shaped cross-section where a cored bar 8 with a roughly U-shaped cross-section is inserted, and that inserted and mounted into a flange 7a of a body panel 7 as shown in FIG. 2 and FIG. 3, a hollow seal 11 that juts out from the side of a grip 9 and that make contact flexibly with the door and to seal a gap from the door when the door is closed, and a lip 13 that extends from the top of the grip 9 in the reverse direction of the seal 11, and that covers an interior trim 12 and makes contact flexibly with it.

The molded part 3 separably joined to the inner seal 2 without being integrated is composed with a seal 15 that covers and is joined to the upper end of the hollow seal 11, a lip 16 that covers and is connected to the lip 13 and a base 17 attached to the body panel 7, and the molded part 3 is fixed to the body panel 7 by a clip 18 at said base 17.

When the weather-strip and the inner seal are integrally joined at the molded part, the entire length becomes longer.

In the meantime, when the weather-strip and the inner seal are separably joined, the weather-strip and the inner seal can be mounted to the body individually, by which design the seal member becomes miniaturized and the handling properties are improved and it has excellent carriability; concurrently improving ease of assembly. However, the following problem is still an issue. In other words, in the molded part of the weather-strip, the base is fixed to the body panel by the clip 18, as shown in FIG. 2. However, because the lip 16 merely covers the interior trim 12 without being secured as shown in FIG. 3, when the door is moved in the arrow direction of FIG. 4 and is closed; as shown in FIG. 5, a molded part 19 at the upper end of the weather-strip 4 mounted to the door abuts the molded part 3 at the lower end of the weather-strip 1 and compresses the seal 15. Associated with this, the lip 16 becomes in a state to spring up from the interior trim 12 and to float, a gap ‘d’ being generated from the interior trim 12. The gap ‘d’ is invisible from the outside when the door is closed. When the door is opened and the molded part 19 mounted to the door is away from the molded part 3 mounted to the body, the lip 16 is restored and abuts the interior trim 12 as shown in FIG. 4, removing the gap ‘d’ from the interior trim 12. However, when the door is repeatedly opened and closed and the lip 16 repeatedly springs up, and even when the door is open, the lip 16 is left open, and the gap ‘d’ from the interior trim 12 is not removed, causing disfigurement.

The objective of the present invention is to resolve these problems, and to provide a design such that when the lip of the molded part integrally formed at the end of the weather-strip of the beltline is opened; no gap is generated from the interior trim.

### SUMMARY OF THE INVENTION

A molded part integrally molded at the lower end of the weather-strip mounted to a front pillar of an open-top car or a front pillar and/or a rear pillar of a hard-top car is joined without being integrated to the inner seal mounted to the lower side under the beltline. The molded part is equipped with a base mounted to a body panel by a mounting means, a seal that is integrated with said base part, and that is joined to the seal of the inner seal, and a lip that extends from said seal, and that flexibly makes contact with the interior trim.

The present invention has a restrict means to restrict the lip of the molded part integrally formed at the lower end of the weather-strip from floating from the interior trim associated with deformation of the seal, which is compressed when the door is closed.

The present invention will become more fully understood from the detailed description given in below and the accompanying drawings are given by way of illustration only, and thus, are not limitative of the present invention.

### BRIEF DESCRIPTION OF THE DRAWINGS

FIG. 1: A pattern diagram of a weather-strip mounted to an open-top car

FIG. 2: A detailed diagram of portion ‘a’ in FIG. 1

FIG. 3: A cross-sectional view of a conventional molded part along the A-A line of FIG. 2

FIG. 4: A cross-sectional view along the B-B line of FIG. 2 in the conventional molded part mounted to the body and the door respectively when the door is being closed

FIG. 5: A cross-sectional view along the B-B line of FIG. 2 showing the state where the door is closed and the lip springs up

FIG. 6: A cross-sectional view corresponding to the B-B line of FIG. 2 showing the mounting structure of the molded part relating to the present invention

FIG. 7: A cross-sectional view corresponding to the B-B line of FIG. 2 showing another example of the mounting structure of the molded part relating to the present invention

FIG. 8: A cross-sectional view corresponding to the B-B line of FIG. 2 showing another example of the mounting structure of the molded part relating to the present invention

FIG. 9: A cross-sectional view corresponding to the B-B line of FIG. 2 showing another example of the mounting structure of the molded part relating to the present invention

FIG. 10: A cross-sectional view corresponding to the B-B line of FIG. 2 showing another example of the mounting structure of the molded part relating to the present invention

FIG. 11: A cross-sectional view along the C-C line of FIG. 12 showing another example of the mounting structure relating to the present invention

FIG. 12: A diagram showing the molded part relating to the present invention corresponding to the section ‘a’ in FIG. 1, which is the same subject section of FIG. 2

FIG. 13: A cross-sectional view of another example of the mounting structure relating to the present invention

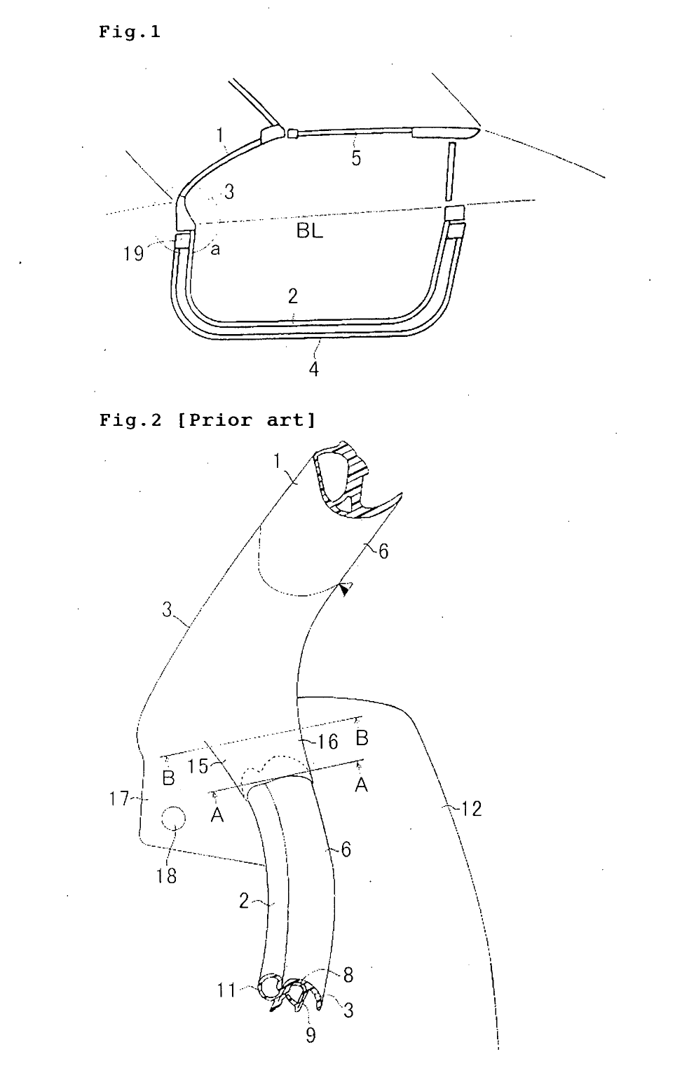

### DESCRIPTION OF THE PREFERRED EMBODIMENT

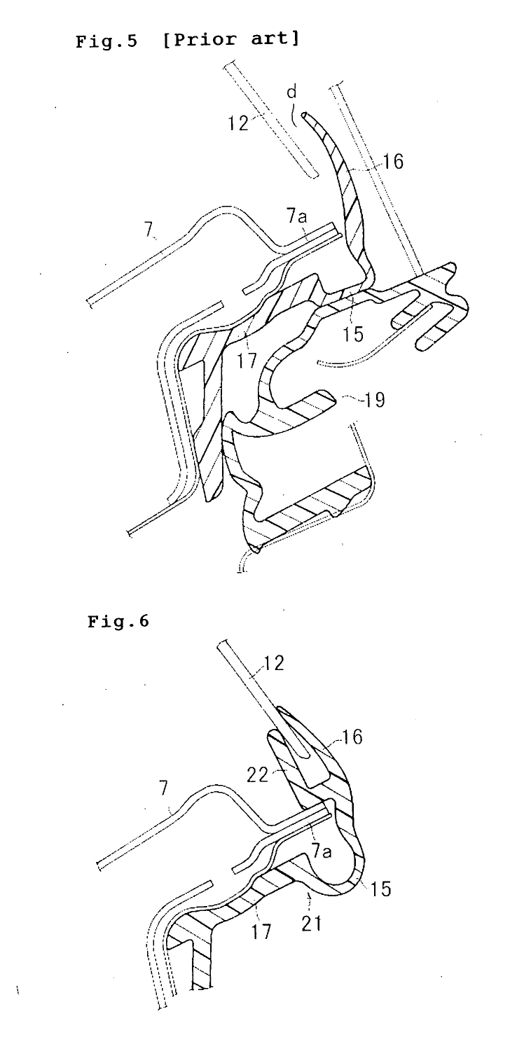

Hereafter, in a joined portion of a weather-strip mounted to the body on the beltline and the inner seal mounted to the lower side of the body under the beltline, which is an embodiment of the present invention; mounting structures of the molded part that is integrally molded to the end of the weather-strip without being integrated with the inner seal are described with reference to the drawings. In the drawings, the same components as those in the structures shown in FIG. 2 to FIG. 5 are marked with the same symbols.

In the molded part 3 where a molded part 21 shown in FIG. 6 is composed of the seal 15 which covers and is joined to the end of the hollow seal 11 of the inner seal 2, and which has a roughly U-shaped cross-section, the lip 16 which extends from said seal 15, and which covers and is joined to the end of the lip 13 shown in FIG. 2, and the base part 17 which is attached to the body panel 7, and which is mounted by a mounting means, such as an un-shown clip or pressure-sensitive adhesive double coated tape; the molded part 21 is equipped with a retainer 22 with an L-shape cross-section, which is protruded integrally with the lip 16 on the rear surface of the lip 16, as a means to restrict the lip 16 from floating from the interior trim 12 when the door is closed; and, said retainer 22 abuts the flanges 7a of the body panel 7 and is supported; concurrently, the end abuts the interior trim 12 from the rear surface and is supported.

According to the present embodiment, when the door is closed, even if the seal 15 is compressed, the end of the retainer abuts the interior trim 12 from the rear surface and is supported, so the lip base is supported and floating of the lip 16 from the interior trim 12 can be restricted. Furthermore, the retainer 22 shown in the diagram is integrally molded with the molded part 21. However, it can be formed by inserting a hook-shaped fitting or plastic material.

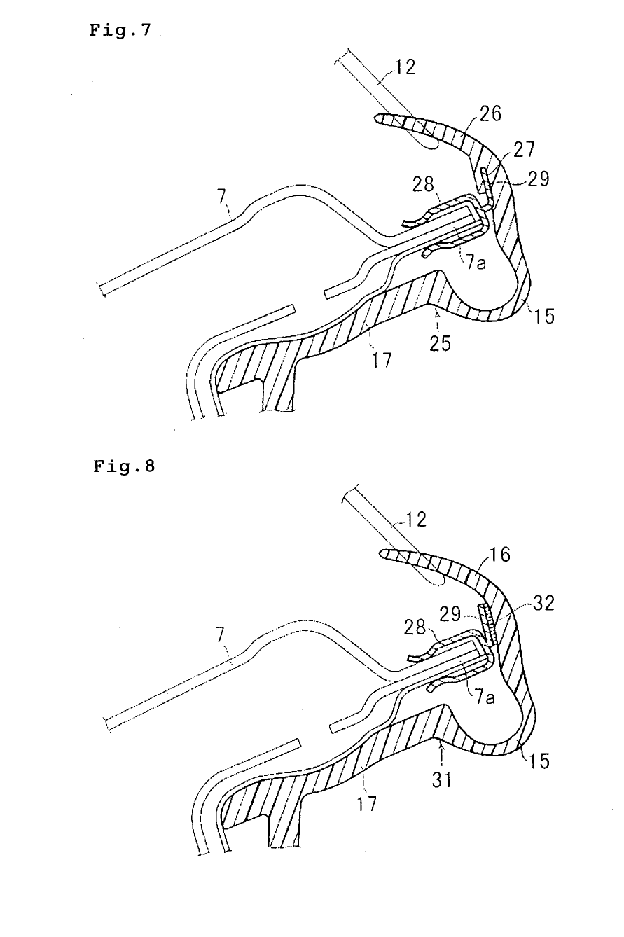

A molded part 25 shown in FIG. 7 restricts the lip 16 from floating when the door is closed, in the molded part 3 with the structure shown in FIG. 2, a plug-in groove 27 is formed on the rear surface of the base of lip 16 that is formed by thickening the base. In the meantime, a grip fitting 28 having a pawl 29 is formed to protrude transversely from the top of the roughly U-shaped cross-section is inserted into the flange 7a of the body panel 7 and mounted. And the pawl 29 is inserted into the plug-in groove 27 of the lip 26 and this lip 26 is retained, and floating of said lip 26 is restricted

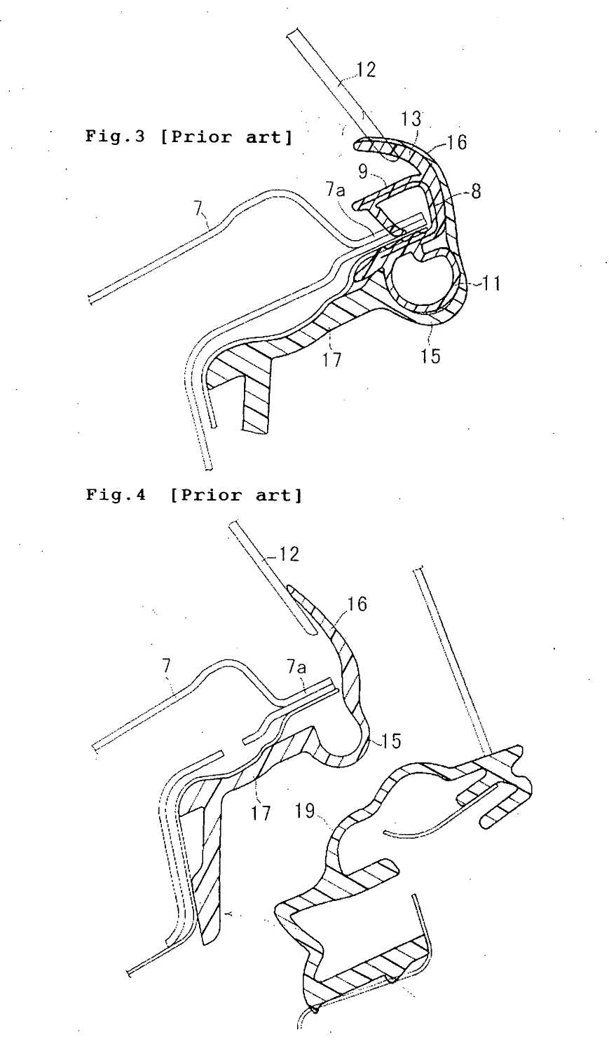

In the example shown in FIG. 7, the grip fitting is used as a mount. However, as shown in the grip 9 in FIG. 3, a mount where a cored bar with a roughly U-shaped cross-section is inserted and a retaining lip butting against the flange 7a is formed inside and inserted into the flange 7a and mounted, which is well-known in resin or rubber weather-strip, can be used, and a plate-state mount to be adhered to the flange 7a using a pressure-sensitive adhesive double coated tape can also be used. Even though the pawl 29 may be made of solid resin or rubber and is integrally mounted to the mount, one made of steel is preferable, and is integrally formed with the cored bar, which is inserted into the resin or rubber mount, or when the mount is made of metal as in the shown embodiments, it is integrally mounted with the mount.

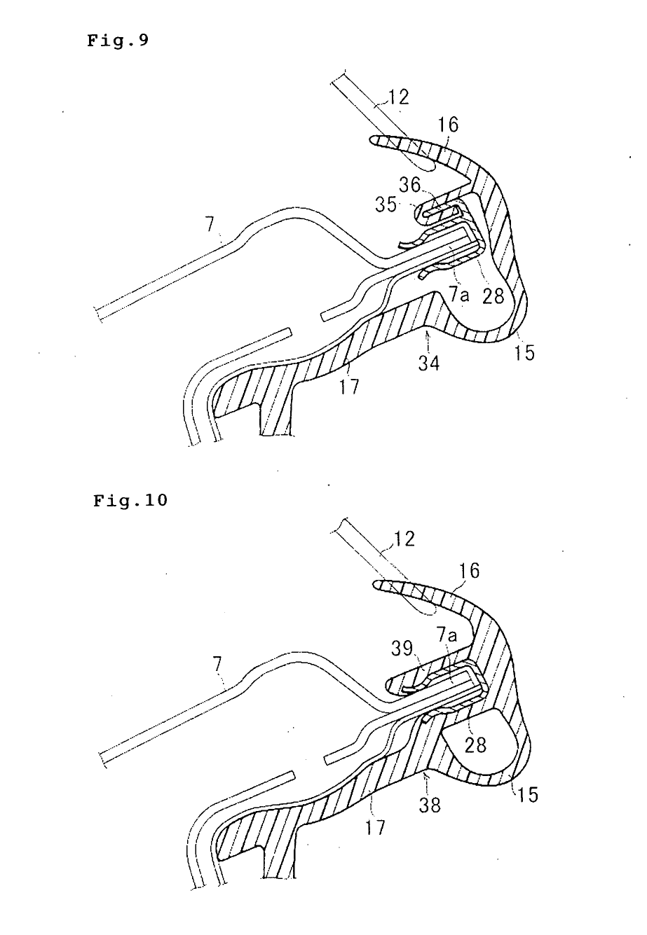

A molded part 31 shown in FIG. 8 has the same structure as that of the molded part 3 shown in FIG. 2. Even in the present embodiment, the above grip fitting 28 is used as a means to restrict the lip 16 from floating, and after the pawl 29 of said grip fitting 28 is adhered and mounted to the rear surface of the lip 16 by the pressure-sensitive adhesive double coated tape 32, which is an adhesive means, the grip fitting 28 is inserted into the flange 7a of the body panel 7 and mounted to it. Instead of mounting the grip fitting 28 to the lip 16 and then inserting it into the flange 7a, after the grip fitting 28 is inserted into the flange 7a, the pawl 29 and the lip 16 can be mounted by adhesion with pressure-sensitive adhesive double coated tape 32.

According to the present embodiment, it is possible to restrict the lip 16 from floating when the door is closed, by merely using the grip fitting 28, without modifying the construction in the conventional molded part 3.

In the present embodiment, although pressure-sensitive adhesive double coated tape 32 is used as an adhering means, an adhesive can also be used.

In a molded part 34 shown in FIG. 9, a plug receptacle 35 with a roughly J-shaped cross-section is integrally formed on the rear surface of the lip 16 as a means to restrict the lip 16 from floating in the molded part 3 shown in FIG. 2. In the meantime, using the grip fitting 28 having a pawl 36 in the state where the pawl 29 of the grip fitting 28 shown in FIG. 7 is bent downward as a mounting means, the downward pawl 36 is inserted into the plug receptacle 35 and the base of the lip 16 is supported, restricting floating at the end side of the lip.

A molded part 38 shown in FIG. 10 is such that the grip fitting 28, which is a mounting means, is integrally formed on the rear surface of the base of the lip 16 as a means to restrict the lip 16 from floating, and the insertion and mounting of the grip fitting 28 of the mount 39 into the flange 7a of the body panel 7 enable the retention of the lip base and the restriction of the end side of the lip from floating. The example of FIG. 10 shows a mode where the grip fitting 28 is inserted into the mount 39. However, the mount 39 can be formed in a protruding state from the lip 16, and be mounted by a mounting means, such as clip or pressure-sensitive adhesive double coated tape.

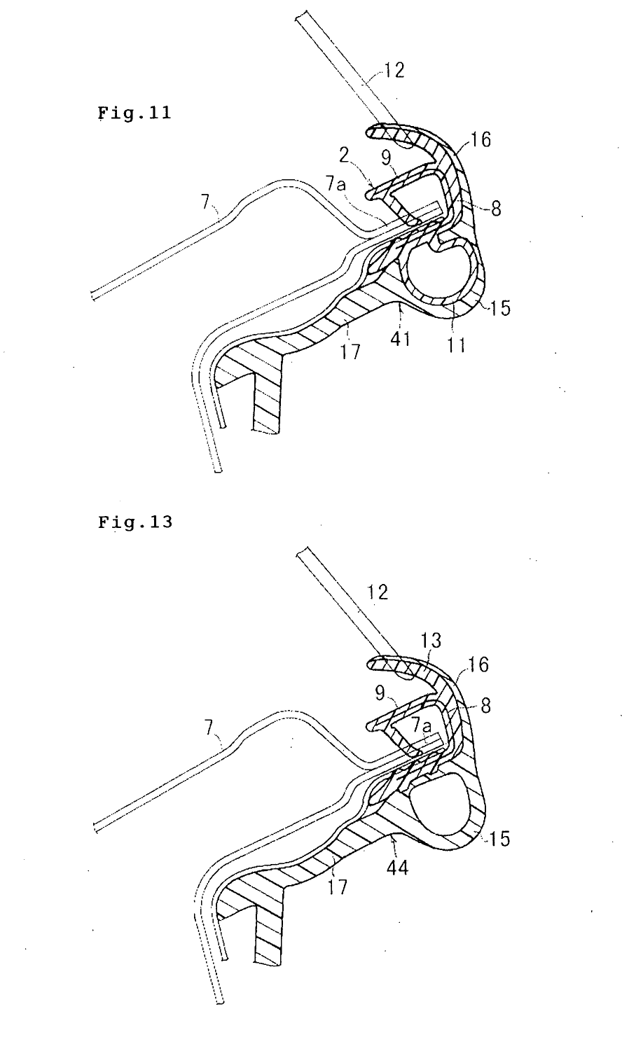

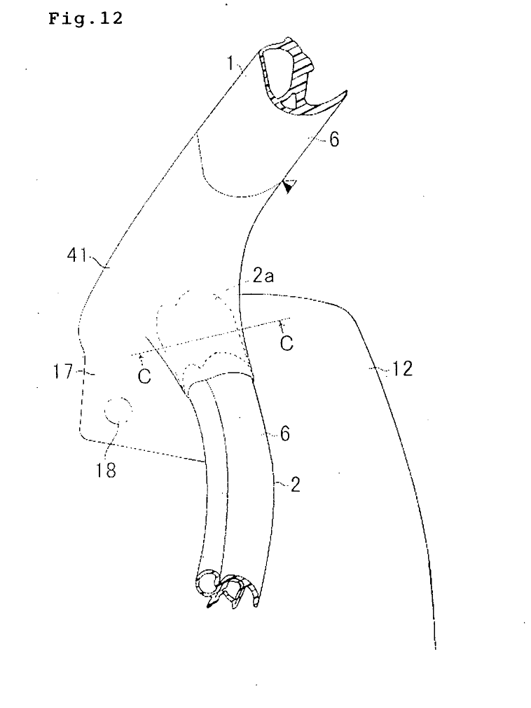

A molded part 41 in FIG. 11 shows the C-C line cross-section of FIG. 12 showing the same subject portion as FIG. 2, and the above-mentioned inner seal 2, i.e., the inner seal 2 composed of the grip 9 where the cored bar 8 is inserted, the hollow seal 11 and the lip 13 is cut to a constant length and is inserted & integrally molded, and the grip 9 is inserted into the flange 7a of the body panel 7, and the lip 16 is retained. In FIG. 12, an inner seal 2a with a constant length inserted into the molded part 41 is joined with the inner seal 2 to be mounted to the body panel 7 at the lower side. However, it can be separated from the inner seal end.

In the present embodiment, in the inner seal 2, although the seal 11 is hollow, it can be in a lip-like state.

In the molded part 41 of the present embodiment, the inserted inner seal 2 is not exposed to the surface of the molded part 3, so a joined line will not be visible like a molded product continuously molded to the molded part, and will never cause disfiguration.

A molded part 44 shown in FIG. 13 is inserted & molded by cutting the inner seal 2 where the hollow seal 11 is removed by cutting a constant length in the components of the inner seal 2, and the insertion of the grip 9 into the flange 7a enables similar retention of the lip 16.

Although the invention has been described in its preferred form with a certain particularity it is unstood that the present disclosure of the preferred form can be arrangement of parts without departing from the spirit and the scoop of the invention as hereinafter claimed.

What is claimed is:

1. A lip retention structure, wherein, a molded part, which is integrally formed at the lower side of a weather-strip that is mounted to a front pillar of an open-top car or a front pillar and/or a rear pillar of a hard-top car, without being integrated with an inner seal mounted to a body at the lower side under a beltline, is composed of a base mounted to the body panel by a mounting means,
a seal joined to the seal of the inner seal, and lips that extend from said seal, and that flexibly make contact with an interior trim; and,
the retention structure is equipped with a restrict means to restrict the lips from floating from the interior trim associated with deformation of the seal, which is compressed when the door is closed.

2. The lip retention structure according to claim 1, wherein, said restrict means is composed with a retainer that juts out from the lip and that supports the lip by abutting against the interior trim from the rear surface.

3. The lip retention structure according to claim 1, wherein, said restrict means is composed of a mount mounted to the body panel, and pawl that is inserted into plug receptacle of the lip, and that retain the lip.

4. The lip retention structure according to claim 1, wherein, said restrict means is composed of the mount mounted to the body panel, a pawl that juts out from said mount, and is along the lip, and an adhering means to adhere said pawl and the lip.

5. The lip retention structure according to claim 1, wherein, said restrict means is integrally formed at an appropriate situation within a range from the seal through the lip, and is composed with a mount mounted to the body panel by the mounting means.

6. The lip retention structure according to claim 1, wherein, said restricted means is inserted & molded to the molded part by cutting at least the grip to a certain length among the components of the inner seal composed of the grip with a roughly U-shaped cross-section that is inserted and mounted into the flange of the body panel, the seal 11 that juts out from said grip, and that flexibly makes contact with the door and seals the gap from the door when the door is closed, and the lip that extends from the grip, and that flexibly makes contact with the interior trim.
